(19) United States
(12) Patent Application Publication
(10) Pub. No.: US 2010/0018646 A1
(43) Pub. Date: Jan. 28, 2010

(54) METHOD AND DEVICE FOR LAMINATING ESSENTIALLY PLANAR WORK PIECES UNDER THE EFFECTS OF PRESSURE AND HEAT

(75) Inventors: Dagmar Metzger, Karlsruhe (DE); Norbert Damm, Karlsdorf-Neuthard (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ROBERT BURKLE GMBH, Freudenstadt (DE)

(21) Appl. No.: 12/496,072

(22) Filed: Jul. 1, 2009

(30) Foreign Application Priority Data
Jul. 2, 2008 (DE) 102008030927.3

(51) Int. Cl. B32B 37/10; B32B 37/02

(52) U.S. Cl. 156/285; 156/382

(57) ABSTRACT

A method and a device for laminating essentially planar work pieces with at least one adhesive layer that can be activated by heat, under the effects of pressure and heat. Initially at least one work piece is inserted into a vacuum chamber of a vacuum lamination press which is divided by a gas-tight flexible compression member into a product half and a pressure half. In the product half of the vacuum chamber, the work piece is subjected to a lamination process under the effects of heat, in which the product half is evacuated and the compression member is pressed directly or indirectly against the bottom of the vacuum chamber by the pressure difference developing here and/or by an additional pressurization of the pressure half of the vacuum chamber. The lamination process is interrupted by opening the vacuum lamination press, the work piece is transferred into a laminator, and here it is subjected to a temperature at or above the activation temperature and/or the curing temperature of the adhesive layer. A film, inserted into the vacuum lamination press separately or together with the work piece or a film web guided through the vacuum chamber, is used as the flexible compression member.

### CROSS-REFERENCE TO RELATED APPLICATIONS

This Application claims the benefit of German patent application 10 2008 030 927.3, filed Jul. 2, 2008, which is incorporated herein by reference as if fully set forth.

### BACKGROUND

The invention relates to a method for laminating essentially planar work pieces under the effects of pressure and heat, as well as a device for laminating such work pieces. The work pieces to be laminated here are designed multi-layered and comprise at least one adhesive layer with an adhesive activated by the effects of heat and, if applicable, also curing under the effects of heat. The preferred application of the present invention is the lamination of photo-voltaic modules, in which a layer of solar cells is encapsulated together with its electric contact elements in a moisture-tight and weather-resistant fashion and yet remains coated in a light-permeable manner.

Within the scope of the present invention a vacuum-lamination press is used. It comprises a vacuum chamber, which is sealed air-tight when the press is closed, and which is divided by a gas-tight flexible compression member into a product half and a pressure half. The product half of the vacuum chamber is provided to accept at least one work piece and can be evacuated. The pressure half of the vacuum chamber can also be evacuated, and, if applicable, can also be impinged with pressure by introducing compressed air or other gases. The flexible compression member is embodied and arranged such that, based on a pressure difference created in the vacuum chamber by evacuating the product half and/or by perhaps impinging the pressure half with additional pressure, the work piece presses directly or directly against a bottom of the vacuum chamber. The bottom is usually a heating plate, which transfers the necessary processing heat to the work piece.

Such a vacuum laminating press is known, for example, from WO 2006/128699 A2. Here, an upper part with a sealing frame is arranged above a heating plate, circumscribing a vacuum chamber. When closing the press the sealing frame is placed onto the heating plate in a sealing fashion so that the vacuum chamber can be evacuated. A flexible membrane is stretched over the sealing frame, sealing the vacuum chamber and serving as flexible compression member in order to apply the pressure against the heating plate necessary for laminating the work piece. For this purpose, the volume, located underneath the membrane between said membrane and the heating plate forming the product half of the vacuum chamber when the press is closed, is evacuated so that the membrane closely contacts the work piece. If necessary, additionally a pressure half of the vacuum chamber, formed by sealing the sealing frame against the upper press plate and limited towards the bottom by the membrane is impinged with compressed air.

When laminating photo-voltaic modules it previously has been necessary to operate with such membranes because these modules usually show an uneven surface and yet an even compression thereupon is necessary in order to ensure that the lamination occurs free from bubbles, because the formation of bubbles during lamination would result in imperfect seals allowing moisture to enter the photo-voltaic modules.

Due to the fact that for laminating photo-voltaic modules generally very strong acting adhesives are used an additional separating film is used in WO 2006/128699 A2 arranged between the work piece and the membrane and protecting the membrane from adhesive remnants potentially exiting from the work piece; because adhesive remnants can render the membrane useless or at least aggravate the processing results in subsequent laminating processes; simultaneously such adhesive remnants can hardly be removed with any acceptable expense from the membrane provided in the interior of the vacuum chamber.

The yield of electric energy from photo-voltaic modules is directly dependent on its area. Therefore, the processing capacity per area unit directly influences the cost efficiency when producing the modules in temporarily fixed processes like the one of lamination.

One way to increase the processing capacity per area unit comprises using multi-tiered vacuum lamination presses. However, here the already high energy consumption during the heating and cooling cycles increases due to the reduced interaction of the individual heating plates with their environment.

In the present method and the present device, a different method is used to increase the processing capacity: the shortening of the processing cycles. For this purpose, the lamination process is interrupted in the vacuum lamination press by opening the press as soon as the adhesive layers have been activated to such an extent that the removal of gaseous components in the vacuum of the product half of the vacuum chamber has concluded or has ended by the activation of the adhesive layer, and inversely the influx of air from the outside into the work piece and/or between its layers has been excluded. At this time of the lamination process the work piece is removed from the opened vacuum lamination press, because any further processing, i.e. usually curing the adhesive layer, is no longer required to occur in a vacuum. This is rather performed by a laminator not containing any vacuum chambers, which impinges the work pieces with a temperature at or above a final temperature, which perhaps is equivalent to the curing temperature of the adhesive layer. Therefore the vacuum-lamination press is ready much faster for another processing cycle than in case where the curing of the adhesive layer is performed entirely in the vacuum lamination press. One example for such a method is disclosed in WO 94/29106 A1.

### SUMMARY

The present invention is based on the object of improving a method and a device of the type noted at the outset with regard to investment and operating costs as well as regarding the maintenance expense.

This object is attained in a method having the features of the invention as well as a device according to the invention.

Preferred embodiments of the method according to the invention and preferred embodiments of the device according to the invention are disclosed in detail below.

The present invention provides a method and a device of the present type in which a film is used as a flexible compression member, which is not locally fixed in the vacuum lamination press but is inserted separately into the vacuum chamber or is introduced together with the work piece. The film may also be provided in form of a film web guided through the vacuum chamber so that the section of the film web respectively acting as the compression member inside the vacuum chamber, driven outside the vacuum chamber, can be inserted into it and can be moved out of it. The membrane that is arranged in a fixed manner and tensile-elastic, which was considered indispensable in lamination presses of prior art, is omitted here.

The flexible compression member is therefore no longer arranged fixed inside the vacuum lamination press, as it had been in the past, but similar to the work piece it is inserted into the press and then removed therefrom. This not only considerably reduces the maintenance expense, because the exchange of worn or damaged membranes is entirely omitted, but the production of a vacuum lamination press equipped according to the invention also becomes more cost effective. Simultaneously the operating safety of the vacuum lamination press is increased, because any adhesives perhaps leaving the work piece can still reach the flexible compression member, however this fails to result in any problems because such a flexible compression member according to the invention that is contaminated with adhesive remnants can be removed from the vacuum lamination press and thus the processing result of the subsequent lamination processes is not compromised. Down times due to maintenance and malfunctions caused by membrane exchanges are therefore a thing of the past. This is particularly advantageous because the down times during membrane exchanges are not negligible: In order to exchange the membrane of a vacuum lamination press of prior art, the press first has to be cooled and after the disassembly of the old and the reassembly of the new membrane, it must be reheated.

In order to protect the membrane of a vacuum lamination press of prior art from any direct contact with adhesives potentially exiting the work piece it has already been common to place a separating film between the work piece and the membrane, which is typically provided in form of a web and comprises a material that can easily be separated from the work piece. Here, the use of a quasi-continuous film web is most efficient, inserted together with the work piece into the vacuum lamination press or, if applicable, also independent therefrom, which only must be modified for realizing the present invention to the extent that it can perform the objects of the previously common, fixed membrane, i.e. dividing the vacuum chamber into a product and a pressure half in a gas-tight fashion and withstanding the pressure differences existing in the vacuum chamber of the vacuum lamination press and the mechanical stress at the work piece. Due to the fact that such a material is of relatively high value such a film web may also be provided not in a quasi-continuous fashion but actually in a continuous one, i.e. traveling in one piece around the upper part of the vacuum lamination press, with here preferably a cleaning device ensuring the removal of potential adhesive residue.

For the rest, less demanding requirements are set for the material of films according to the invention used as the flexible compression member than for the membranes used in vacuum lamination presses of prior art, being not only flexible but also tenso-elastic. This highly elastic membrane contacts very closely (particularly desired in the production of furniture plates, for example) and largely also to the edges of the work pieces. In the present invention this is unnecessary, though, and rather disadvantageous even because this way increased pressure results in the edge regions of the work pieces, which particularly in photo-voltaic modules can lead to glass breaking or to fractures of solar cells arranged at the edges. A less elastic and/or non-elastic and thus more cost-effective film material helps to avoid such pressures.

Preferably several work pieces or several work piece groups, when more than one work piece is being processed simultaneously in the vacuum lamination press, are laminated in series and the introduction of the work pieces into the vacuum lamination press and the transfer of the work pieces into the laminator occurs in a synchronized fashion.

When the operating cycle of the preliminary lamination in the vacuum lamination press is shorter than the operating cycle of the laminator for curing the adhesive layers, it may be useful to provide more than one laminator downstream in reference to the vacuum lamination press. For example, when two laminators are used the curing cycle may be twice as long as the operating cycle of the vacuum lamination press, without having to accept any idling of the vacuum lamination press.

Instead of one or more additional laminators or in addition thereto, a cooling device for cooling the work piece can be provided downstream to cool the work piece to a temperature below the softening temperature of the adhesive layer. Such a cooling device is preferably embodied as a press to cool the work pieces at a cooling plate using contact pressure.

According to the present invention it is possible to allow the progression of the preliminary lamination in the vacuum lamination press at such low temperatures that the adhesive layer softens and/or begins to soften, however that it does not liquefy to such an extent that is must be feared that residue of adhesives reach the compression member or the bottom of the vacuum chamber usually embodied as a heating plate. The further processing in the laminator arranged downstream then occurs at the final temperature, particularly at a curing temperature of the adhesive layer; however, this can occur here without any flexible compression member.

In general, the method according to the invention and the respective device comprises the advantage that the temperature controls in the different stations, i.e. the vacuum lamination press, the laminator and if applicable additional laminators, can be set independent from each other so that the coordination of heating and pressure can be controlled in a much more individual fashion than in the entire lamination process being performed in a single vacuum lamination press. For example, the target temperature can be selected much higher in the vacuum lamination press than the final temperature in order to ensure the rapid heating of the work piece. In this case, the process should be interrupted at an appropriately early time before the work piece has reached the final temperature. Inversely, the final temperature in the vacuum lamination press can also be selected considerably lower than the final temperature for the adhesive layer so that the heating of the work pieces occurs slower, if desired, and simultaneously the energy consumption is minimized.

In a corresponding fashion, the lamination process can be improved with regard to energy consumption as well as an optimized temperature control in that several laminators can be arranged successively, with their target temperatures varying from one laminator to another one, particularly increasing.

In order to regulate the introduction of heat into the work pieces and for an improved pressure distribution the work pieces can be placed onto pressure pads or cushions and/or the work pieces can be covered therewith in the vacuum lamination press and/or in the laminator and /or in the cooling device. Here it is irrelevant for their effect if such pressure pads or cushions are installed locally fixed in the machines or inserted loosely into the processing chambers together with the work pieces. In order to additionally influence the temperature control in the work piece here pressure pads or cushions can be used that show defined heat conductivity characteristics and accordingly delay the heat transfer in a defined fashion.

### BRIEF DESCRIPTION OF THE DRAWINGS

In the following, some exemplary embodiments of the present invention are described and explained in greater detail using the attached drawings. Shown are:

FIG. 1 is a schematic partial side view of an open vacuum lamination press;

FIG. 2 is a schematic partial side view similar to FIG. 1 of another embodiment of the invention;

FIG. 3 is a schematic side view of a product line embodied according to the invention comprising a vacuum lamination press, a laminator, and a cooling device;

FIG. 4a and 4b are schematic side views of work pieces to be laminated;

FIG. 5 is a schematic illustration of a production line equipped according to the invention;

FIG. 6 is a schematic illustration of a variation of a production line equipped according to the invention;

FIG. 7 is a diagram of various parameters of the processed work pieces over time in a vacuum lamination press of prior art;

FIG. 8 is a diagram similar to FIG. 7, however with a process, divided according to the invention, in a vacuum lamination press and two subsequent laminators;

FIG. 9 is an illustration similar to FIG. 8, however using different framework conditions;

FIG. 10 is a view showing an addition to FIGS. 8 and 9 in the form of a cooling station.

### DETAILED DESCRIPTION OF THE PREFERRED EMBODIMENTS

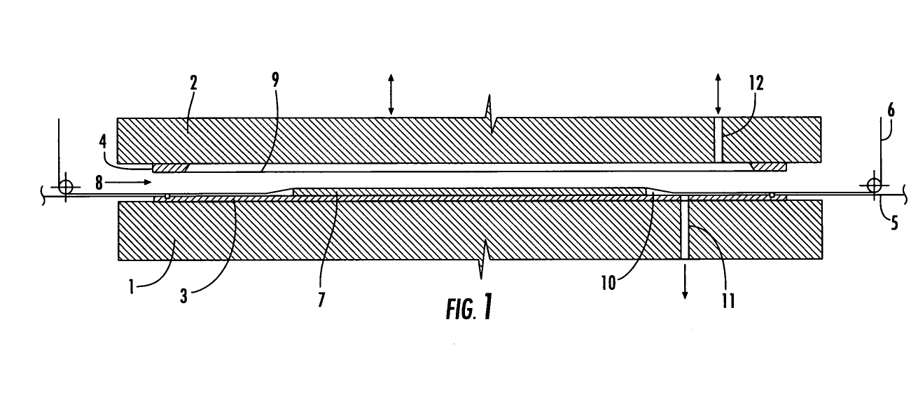

FIG. 1 shows a schematic partial side view of a vacuum lamination press with a lower press part 1, an upper press part 2, as well as a heating plate 3 and a sealing frame 4. A conveyer belt 5 as well as a separating film 6 travel between the heating plate 3 and the sealing frame 4. Arranged between the conveyer belt 5 and the separating film 6 a work piece 7 is arranged on a heating plate 3 in order to be pre-laminated after the shown press has been closed. When the press is closed the heating plate 3, the upper press part 2, as well as the sealing frame 4 form the limits of a vacuum chamber 8, which is divided by the separating film 6 into a pressure half 9, limited by the upper press part 2, the sealing frame 3, and the separating film 6, and a product half 10, which is limited by the heating plate 3 and the separating film 6. The product half 10 can be evacuated via a channel 11, shown only schematically, while the pressure half 9 can also be evacuated via an also only schematically shown channel 12 or can be impinged with compressed air.

When the press shown in FIG. 1 is closed, first the pressure half 9 of the vacuum chamber 8 is evacuated by way of suctioning via the channel 12 in order to lift the separating film 6 off the work piece 7. Almost simultaneously the product half 10 of the vacuum chamber 8 is evacuated by way of suctioning via the channel 11 in order to avoid the formation of bubbles in the adhesive layers of the work pieces 7. Here, a pressure difference between the pressure half 9 and the product half 10 is maintained, which continues to keep the separating film 6 at a distance from the work piece 7. After a vacuum in the product half 10 has been created sufficient to prevent the formation of bubbles, the pressure half 9 is ventilated to such an extent that the pressure difference is reversed. Due to the pressure difference developing here between the pressure half 9 and the pressure half 10 of the vacuum chamber 8 the separating film 6 closely contacts the work piece 7 and presses it against the heating plate 3. If applicable, the pressure difference is increased by introducing compressed air through the pressure channel 12 into the pressure half 9 of the vacuum chamber 8. In order to keep the pressure difference low to the extent necessary the pressure half 9 of the vacuum chamber 8 may also remain evacuated.

After the heating of the work piece 7 by contacting the heating plate 3 has progressed to such an extent that a softening of the adhesive layers has occurred; however, when curable adhesives are used, the curing temperature of the adhesive layers has not been reached, the vacuum chamber 8 is aerated on both sides, the press is opened, and the work piece 7 is removed out of the press on the conveyer belt 5 and transferred into a laminator (not shown here).

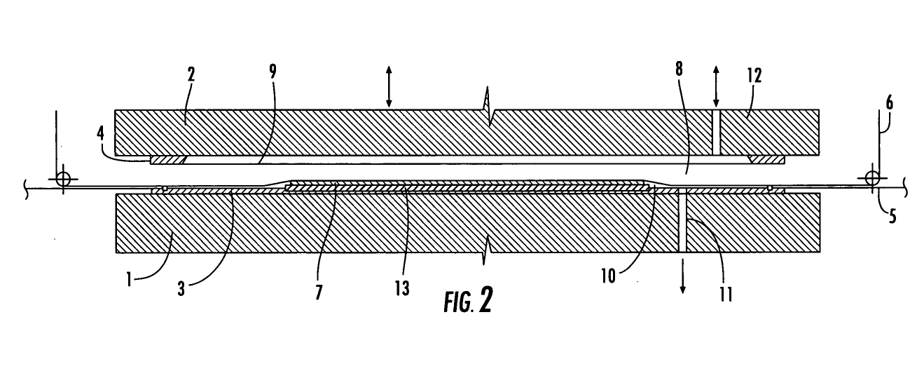

FIG. 2 is an illustration almost identical to FIG. 1, however (showing) a modified exemplary embodiment. Identical elements are marked with the same reference characters so that essentially reference can be made to the description of FIG. 1. The difference from the exemplary embodiment according to FIG. 1 lies in a pressure pad 13 placed between the heating plate 3 and the work piece 7. On the one hand, it compensates any potential uneven sections or tolerances in the parallelism of the work piece 7. On the other hand, it delays the heat transfer from the heating plate 3 into the work piece 7 by defined heat conductivity features in a predetermined fashion such that an evacuation of the product half 10 of the vacuum chamber 8 can occur to avoid the formation of bubbles in the work piece 7 before the work piece 7 considerably heats up.

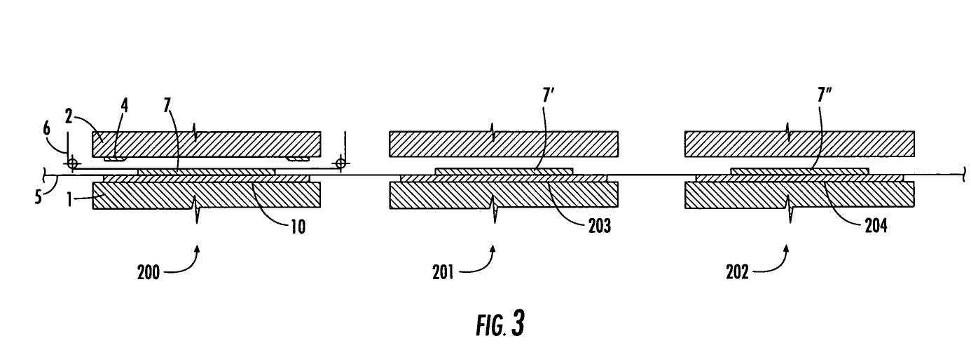

FIG. 3 shows a schematic side view of an exemplary embodiment for a device according to the invention for laminating photo-voltaic modules divided into three stations, namely a vacuum lamination press 200, a laminator 201, and a cooling device 202. Both, the laminator 201 as well as the cooling device 202, are embodied as presses, with the laminator 201 comprising a heating plate 203 and the cooling device 202 comprising a cooling plate 204 for heating and/or cooling the work piece 7′ and 7″. A sealing frame 4 is only present in the vacuum lamination press 200; this is not necessary in the laminator 201 and the cooling device 202. The conveyer belt 5 guides a number of work pieces 7, 7′, 7″ shown here in a clocked fashion through the three stations 200, 201, 202, while the separating film 6 is only provided at the vacuum lamination press 200 and here forms the elastic compression member. Of course, it is also possible to guide the separating film 6 through all three stations 200, 201, 202 in order to prevent the possibility of adhesive residue sticking to the respective upper parts of the press, or individual separating films or film webs can be used in the respective stations 200, 201, 202.

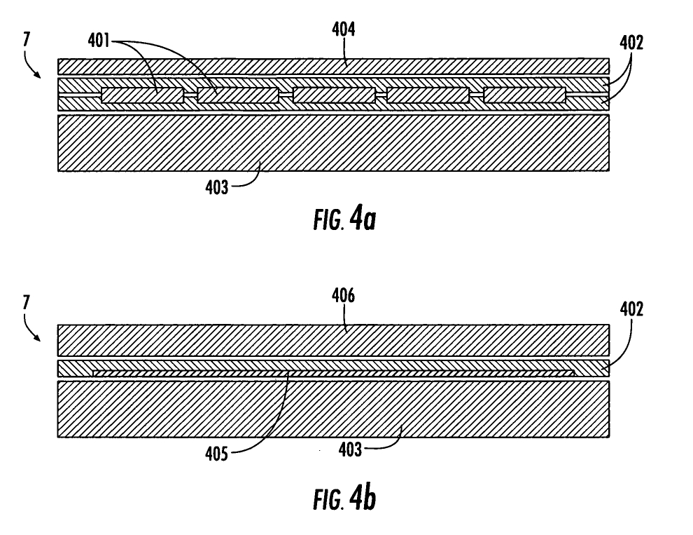

An example of a work piece 7 is shown in FIG. 4a, which is to be laminated with the method according to the invention. It relates to a silicon solar-cell module with a number of silicon solar-cells 401 embedded between two adhesive films 402. The front of the module is formed by a glass substrate 403, while a rear film 404 is placed onto the back of the module. The work piece 7 shown is laminated by the method according to the invention such that the glass substrate 403, the silicon solar-cell 401, and the rear film 404 are connected to each other durably and in a weather-resistant fashion based on an adhesive comprised in the adhesive films 402, acting cross-linking or purely in an adhesive fashion.

FIG. 4b shows another example for a work piece 7 to be laminated, which again is embodied as a photo-voltaic module. However, it includes a thin-layer solar cell 405, which is embedded in an adhesive film 402 between a substrate glass 403 and a glass back 406. After the lamination process the substrate glass 403 and the glass back 406 is connected permanently and in a weather resistant fashion to the thin-layer solar cell 405 positioned therebetween.

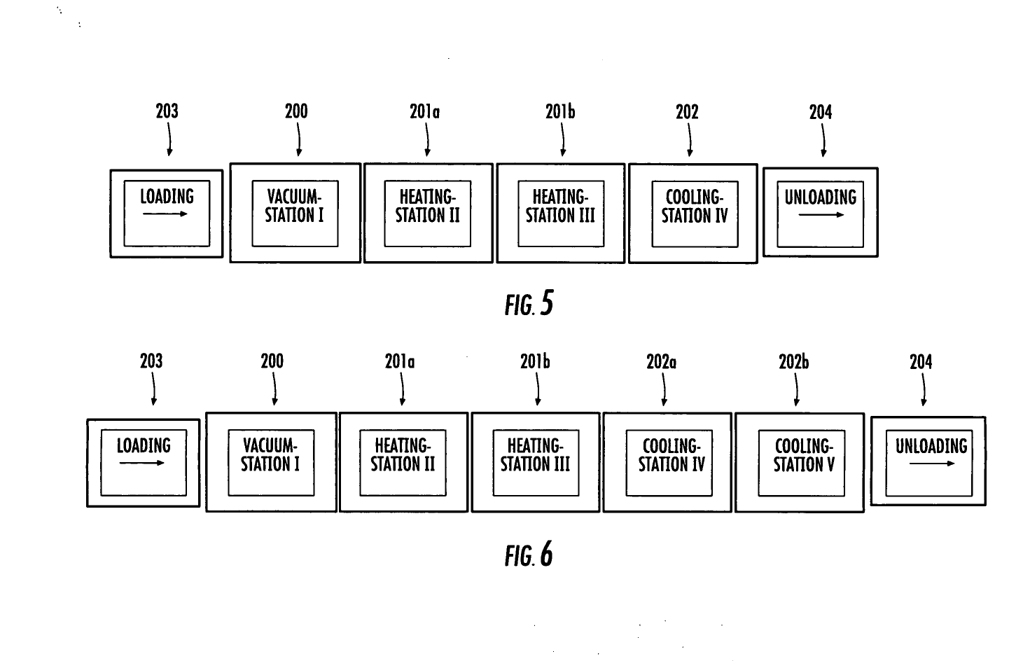

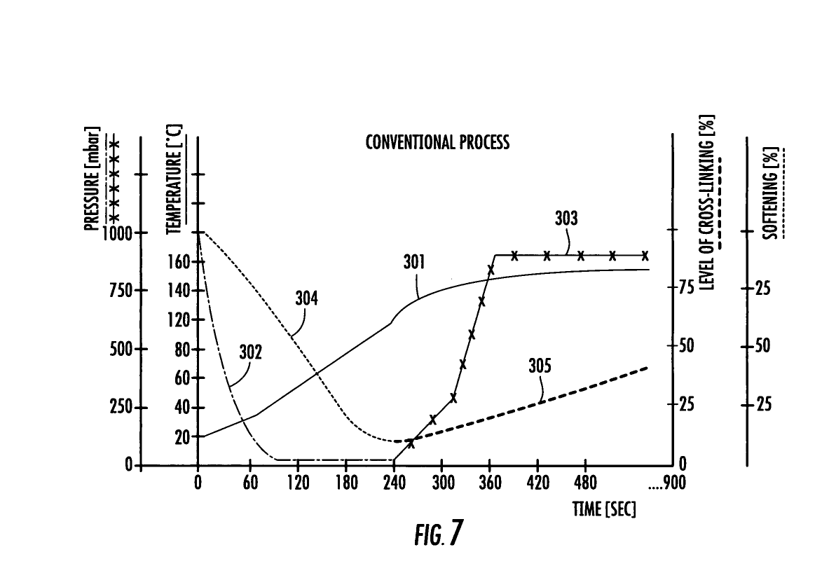

FIGS. 5 and 6 show schematically two different exemplary embodiments for a device according to the invention with, in the exemplary embodiment according to FIG. 5, a vacuum lamination press 200 (vacuum station I) that is followed downstream by two laminators 201a and 201b (heating stations II and II), as well as a cooling station 202 (cooling station IV). In order to load the vacuum lamination press 200, a loading device 203 is provided, while for unloading the cooling device 202 an unloading device 204 is arranged down-stream. In the exemplary embodiment according to FIG. 12, instead of a single cooling device 202, two cooling devices 202a and 202b are provided, for example to adjust the processing cycle to the vacuum lamination press 200, with its processing cycle also being too short to allow any cooling of the completely laminated work pieces in a single cooling station.

In the following description of a method of prior art and a method according to the invention it is assumed, for example, that in the adhesive layers of the work pieces, cross-linked adhesives are used that cure under the effects of heat. Here, it should be mentioned, though that within the scope of the present invention other thermally reactive adhesives acting purely in an adhesive manner may be used; the invention is therefore suitable and advantageous both for a use of thermoset materials as well as thermoplastics.

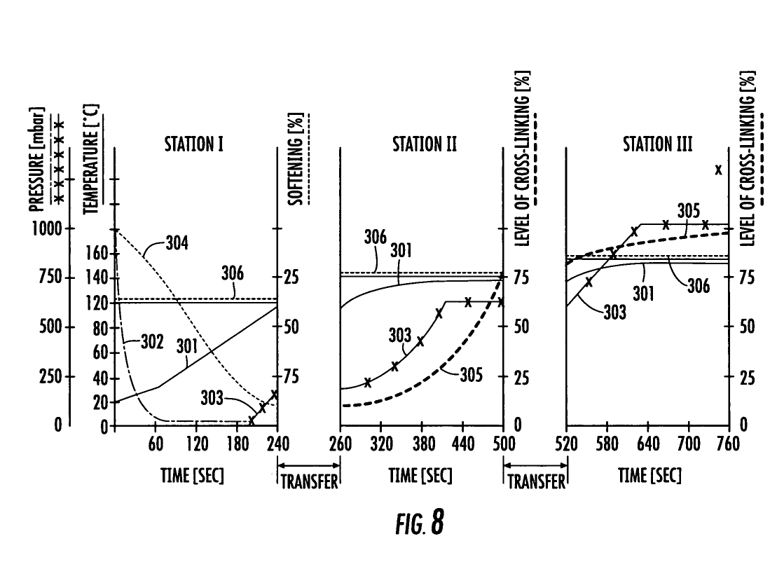

FIG. 7 shows a diagram of different framework conditions of a conventional process in a vacuum lamination press. According to prior art, here the work pieces are processed until the adhesive layers are cured in the vacuum lamination press. The continuous line 301 shows the temperature in the work piece, while the dot-dash line 302 shows in the first half of the diagram the air pressure in the product half of the vacuum chamber and in the second half as line 303 the contact pressure affecting the work piece. In case of the line 302 shown directly in the form of gas pressure in mbar and in the case of the line 303 equivalent to the gas pressure in mbar. As a consequence of these framework conditions (pressure and temperature) the dot-dash marked lines 304 and 305 result, with the line 304 illustrating the softening of the adhesive layers in %, while the line 305 illustrates the web level of the adhesive layers, here by a cross-linking adhesive.

As discernible from this diagram the temperature of the work pieces increases along the line 301 beginning at room temperature (20° C.) to the target temperature (approx. 150° C.), with the rise of the line 301 depending on the heat transfer between the heating plates and the work pieces.

Based on the rapidly falling line 302 it is discernible that the product half of the vacuum chamber is evacuated as fast as possible, before the work pieces heat to a considerable extent. With the temperature of the work piece still being below 50° C. the pressure in the vacuum chamber is reduced to almost 5 mbar, so that any formation of bubbles in the adhesive layers is avoided. The softening (line 304) of the adhesive layers increases according to the rise in the temperature 301 of the work piece. When a temperature of approximately 120° C. has been reached and a softening level of more than 80%, the pressure half of the vacuum chamber is ventilated so that the compression member, separating the pressure half from the (still evacuated) product half of the vacuum chamber, applies an increasing compression upon the work piece. This is shown in the line 303. In the present case the pressure half of the vacuum chamber is only aerated but not impinged with additional pressure so that the resulting compression (line 303) acting upon the work piece remains slightly below the atmospheric pressure. The level of interlocking (305) of the adhesive layers increases with rising pressure (303) and rising temperature (301) so that curing occurs. The contact pressure of the work piece against the heating plate, developing by aerating the pressure half of the vacuum chamber, naturally increases the heat transfer into the work piece, with the temperature (301) rising faster until it approaches the target temperature.

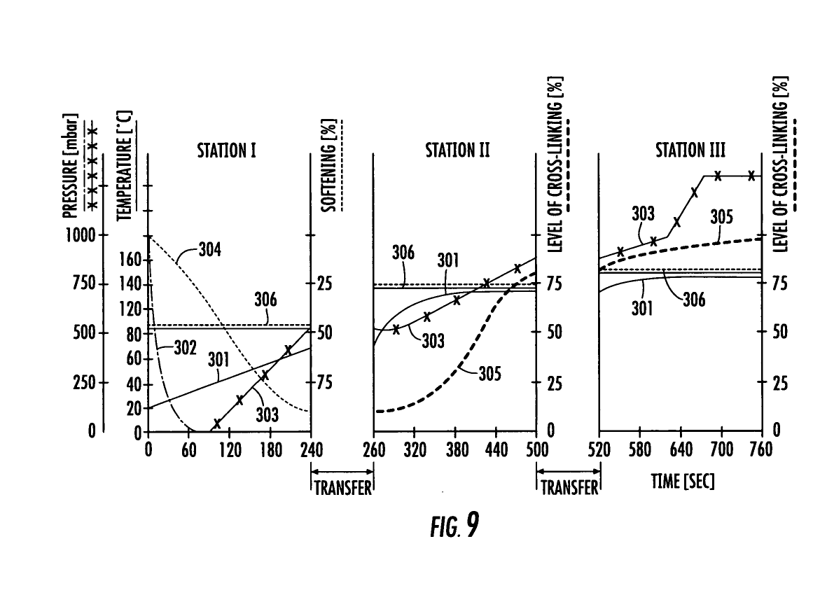

Contrary thereto, FIG. 8 shows a first example for a process divided according to the invention, with station I representing the vacuum lamination press, station II the laminator, and station III a second laminator. The cooling device is illustrated as station IV in FIG. 10.

As discernible from FIG. 8, here in station I the pressure is reduced as fast as possible in the product half of the vacuum chamber (line 302) in order to prevent the formation of bubbles in the adhesive layers. Due to the fact that the process according to the invention is divided into several stations the target temperature is not required to be at or above the curing temperature of the adhesive layers, as in the processes of prior art, but can be selected lower. In the present (example) the target temperature is given as 120° C., which is illustrated in a double-line 306.

Due to the reduced target temperature 306, the work piece heats slower which results in a less inclined temperature curve 301. Accordingly the softening 304 of the adhesive layers also occurs slower, so that the evacuation of the product chamber (line 302) can be performed prior to any considerable softening of the adhesive layers.

The curing of the adhesive layers then occurs gradually in the stations II and III, i.e. in two consecutive laminators. In the first laminator (station II) the target temperature 306 is still at a reduced level in reference to the curing temperature, here at approx. 140° C., so that the temperature 301 only slowly approaches the target temperature 150° C. in the second step in station III. Due to the fact that the laminators of the stations II and III are embodied as hot presses the compression affecting the work pieces, as shown by line 303, can be controlled for an optimized interlocking (line 305). For the rest, by initially ventilating the pressure half of the vacuum chamber in station I only at one side and only thereafter aerating both sides for opening the vacuum lamination press, a certain compression, line 303, already acts upon the work piece in station I.

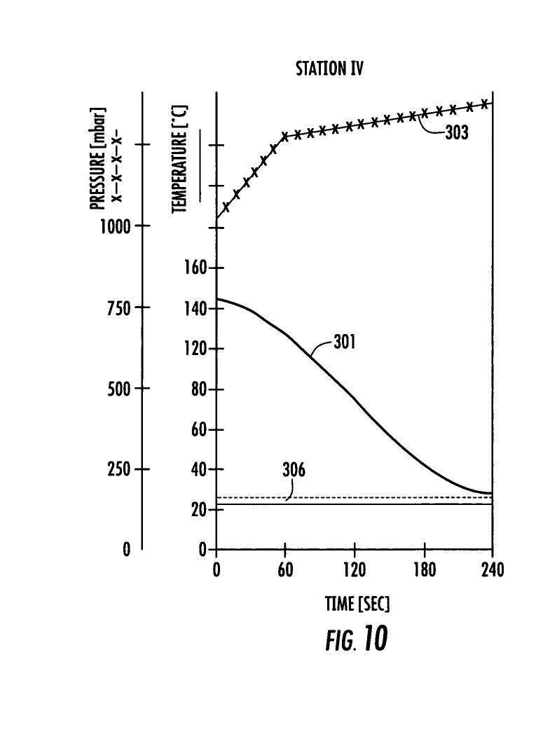

FIG. 9 shows another example of processing using the method according to the invention, equivalent to the example shown in FIG. 8, however embodied differently with regard to the process parameters. Here, particularly in station III, a higher compression is applied upon the work pieces, while the target temperatures are selected similar to the example according to FIG. 8. Here the impinging of the work pieces with a compression in station I to better avoid any formation of bubbles during the preliminary lamination is also performed earlier and to a greater degree.

FIG. 10 completes both FIG. 8 as well as FIG. 9 with a station IV representing the cooling device. Accordingly, here the target temperature 306 is at room temperature and the progression of the temperature 301 of the work piece is falling, from the curing temperature of almost 150° C. to room temperature. The heat transfer from the cooling plates (306) to the work pieces (301) is improved by a compression 303, thus the cooling device (station IV) is embodied as a press with cooling plates.

Finally, it is noted that both, the vacuum lamination plate as well as the laminator and perhaps additional laminators or cooling devices, may be embodied each in one or more tiers.

1. A method for laminating essentially planar work pieces with at least one adhesive layer that can be activated by heat under the effects of pressure and heat, comprising:
initially inserting at least one work piece into a vacuum chamber of a vacuum lamination press, divided by a gas-tight flexible compression member into a product half and a pressure half,
subjecting the work piece in the product half of the vacuum chamber being a lamination process under the effects of heat, including evacuating the product half and pressing the compression member directly or indirectly against a bottom of the vacuum chamber by at least one of a developing pressure difference or an additionally impinging pressure of the pressure half of the vacuum chamber to press the work piece, and
interrupting the lamination process by opening the vacuum lamination press, transferring the work piece into a laminator, and impinging the work piece here with a temperature at or above at least one of an activation temperature or a curing temperature of the adhesive layer, and
either inserting a film into the vacuum lamination press separately or together with the work piece or guiding a film web through the vacuum chamber as the flexible compression member.

2. The method according to claim 1, wherein the film web guided through the vacuum chamber to act as the flexible compression member comprises a material easily separating from the work piece.

3. The method according to claim 2, wherein the film web comprises an adhesive-resistant material,

4. The method according to claim 3, wherein the material comprises a PTFE-film or a substrate film coated with PTFE.

5. The method according to claim 1, further comprising after the laminator, transferring the work piece to another laminator and/or a cooling device for cooling the work piece to a temperature below a softening temperature of the adhesive layer.

6. The method according to claim 1, wherein several of the work pieces or several work piece groups are laminated serially and the insertion of the work pieces into the vacuum lamination press as well as the transfer of the work pieces into the laminator occurs in a clocked fashion.

7. The method according to claim 1, further comprising inserting pressure pads or cushions with respectively defined heat conductivity features between the work piece and respective heat exchange surfaces to influence temporal heat effects upon the adhesive layer of the work piece in at least one of the vacuum lamination press, the laminator or a downstream cooling device.

8. The method according to claim 1, further comprising controlling the heat effect upon the work piece in the vacuum lamination press such that the adhesive layer is softened and the lamination process begins, and a temperature in the adhesive layer remains below the final temperature.

9. The method according to claim 8, wherein for controlling the heat effects in the vacuum lamination press, a target temperature is selected appropriately low or the process is interrupted at an appropriately early time.

10. The method according to claim 9, wherein several consecutive laminators are used, with target temperatures thereof varying from one laminator to another.

11. A device for laminating essentially planar work pieces (7), provided with at least one adhesive layer (402) that can be activated by heat under the effects of pressure and heat, comprising a vacuum lamination press (200) with a vacuum chamber (8), divided by a gas-tight flexible compression member (6) into a product half (10) and a pressure half (9), with the product half (10) being able to accept at least one work piece (7) and which can be evacuated, the pressure half (9) can be evacuated and impinged with pressure, and the flexible compression member (8) being embodied such that based on a pressure difference in the vacuum chamber (8) existing due to evacuation of the product half (10) and/or by pressurization of the pressure half (9) the work piece (7) is directly or indirectly pressed against a bottom (3) of the vacuum chamber (8), at least one laminator (201) arranged downstream in reference to the vacuum lamination press (200), in which the work piece (7) is impinged with a temperature at or above an activation temperature and/or a curing temperature of the adhesive layer (402), and conveyer devices (5) for transporting the work piece (7) into the vacuum lamination press (200) and for transporting the work piece (7) from the vacuum lamination press (200) into the laminator (201), the flexible compression member comprises a film (6) that is insertable separately or together with the work piece (7) into the vacuum lamination press (200) or a film web guided through the vacuum chamber (8).

12. The device according to claim 11, wherein the flexible compression member is a film web (6) guided through the vacuum chamber (8) and comprises a material that can easily be separated from the work piece (7).

13. The device according to claim 12, wherein the film web (6) is made from an adhesion-resistant material.

14. The device according to claim 13, wherein the material comprises a PTFE-film or a substrate film coated with PTFE.

15. The device according to claim 11, further comprising at least one of another laminator (201a, 201b) or a cooling device (202) arranged downstream in reference to the laminator for cooling the work piece (7) to a temperature below the softening temperature of the adhesive layer (402).

16. The device according to claim 11, further comprising a controller for moving the work pieces through the device in a clocked fashion.

17. The device according to claim 15, further comprising pressure pads (13) or cushions located in at least one of the vacuum lamination press (200), the laminator (201) or the cooling device (202) under the work piece (7), or the pressure pads (13) or cushions are placed upon the work piece (7).

18. The device according to claim 17, wherein the pressure pads (13) or cushions are each provided with defined heat conductivity features to influence temporal heat effects upon the adhesive layer (402) of the work piece (7).

19. The device according to claim 11, a controller that controls a processing temperature in the vacuum lamination press (200) independent from the laminator (201) so that a target temperature can be adjusted higher or lower.

20. A device according to claim 19, wherein the heat effect upon the work piece (7) in the vacuum lamination press (200) is controlled such that the adhesive layer (402) is softened and the lamination process begins, and the temperature in the adhesive layer (402) remains below a final temperature.
